(19) United States
(12) Patent Application Publication
(10) Pub. No.: US 2003/0202356 A1
(43) Pub. Date: Oct. 30, 2003

(54) Means for illuminating wheel

(76) Inventor: Pao-Chuang Hung, Sanchung City (TW)

Correspondence Address: BACON & THOMAS, PLLC, 625 SLATERS LANE, FOURTH FLOOR, ALEXANDRIA, VA, 22314

(21) Appl. No.: 10/134,387

(22) Filed: Apr. 30, 2002

(51) Int. Cl. B60Q 1/00

(52) U.S. Cl. 362/500

(57) ABSTRACT

A wheel made of an optically conductive material is provided at a hub thereof with a power supply device. A plurality of light emitting elements are connected to the power supply device and separately disposed in spokes of the wheel. Alternatively, a plurality of optically conductive elements, which may have a specially designed configuration, shape or color, are separately fixedly mounted on the spokes of the wheel with the light emitting elements mounted therein. Light beams emitted from the light emitting elements are transmitted outward via the spokes or the optically conductive elements to provide a visually good warning effect. Such wheel is particularly suitable for use with bicycles, tricycles, and strollers.

### FIELD OF THE INVENTION

The present invention relates to means for illuminating wheel, and more particularly to means for illuminating a wheel made of an optically conductive material or a wheel including optically conductive elements mounted on spokes thereof. The illuminating means includes a power supply device connected to a hub of the wheel, and a plurality of light emitting elements disposed in the spokes or the optically conductive elements and powered by the power supply device to emit light beams that are outward transmitted via the spokes or the optically conductive elements to provide a visually good warning effect when the wheel rotates.

### BACKGROUND OF THE INVENTION

Bicycles, tricycles, and strollers usually have simpler structures and lower prices as compared with other types of vehicles. To reduce the manufacturing costs thereof, warning and safety devices, such as warning lights, direction lights, illuminating lights, etc., are frequently omitted from these products, making them unsafe for use in the night or at dark places.

A common solution for this problem is to attach reflective strips or sheets to wheels of these products, so that users are somewhat protected against accidents in the night. However, such reflective strips or sheets need external light sources to provide the warning effect.

It is therefore necessary to develop means for illuminating the wheels of bicycles, tricycles, and strollers without the need of any external light source.

### SUMMARY OF THE INVENTION

A primary object of the present invention is to provide a means for illuminating wheel. The wheel is made of an optically conductive material. Or, alternatively, the wheel includes a plurality of optically conductive elements mounted on spokes of the wheel. A plurality of light emitting elements are mounted in the spokes or the optically conductive elements of the wheel and are connected to a power supply device connected to a hub of the wheel to obtain power needed to emit light beams. The light beams emitted from the light emitting elements are transmitted outward via the optically conductive spokes or elements to provide a visually good warning effect when the wheel rotates.

The optically conductive spokes or elements of the wheel are provided on outer surfaces with a plurality of grooves, flanges, coarse areas or holes, so that light beams emitted from the light emitting elements are reflected and refracted at these portions to produce increased number of light spots that create a visual effect that the entire surface of the wheel in rotating is illuminated.

The optically conductive elements may be of any shape, configuration or color to show, for example, a customer's logo, making the wheel in rotating have a unique, changeful, and colorful appearance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of means for illuminating wheel according to a first embodiment of the present invention;

FIG. 2 is an assembled perspective view of FIG. 1;

FIG. 3 is a fragmentary sectioned side view of FIG. 2;

FIG. 4 shows grooves provided on spokes of a wheel as a part of the means for illuminating wheel according to the first embodiment of the present invention;

FIG. 5 shows flanges provided on spokes of a wheel as a part of the means for illuminating wheel according to the first embodiment of the present invention;

FIG. 6 shows coarse areas provided on spokes of a wheel as a part of the means for illuminating wheel according to the first embodiment of the present invention;

FIG. 7 shows holes provided on spokes of a wheel as a part of the means for illuminating wheel according to the first embodiment of the present invention;

FIG. 8 is an exploded perspective view of means for illuminating wheel according to a second embodiment of the present invention;

FIG. 9 is an assembled perspective view of FIG. 8;

FIG. 10 is a fragmentary, enlarged perspective view of a centrifugal type of self-power-generating device as a part of the means for illuminating wheel according to the second embodiment of the present invention, wherein the self-power-generating device is in an open-circuited state;

FIG. 11 is the centrifugal type of self-power-generating device of FIG. 10 in a close-circuited state;

FIG. 12 shows the illuminating means according to the second embodiment of the present invention being mounted on bicycle wheels;

FIG. 13 shows optically conductive elements with grooves as a part of the means for illuminating wheel according to the second embodiment of the present invention;

FIG. 14 shows optically conductive elements with flanges as a part of the means for illuminating wheel according to the first embodiment of the present invention;

FIG. 15 shows optically conductive elements with coarse areas as a part of the means for illuminating wheel according to the first embodiment of the present invention;

FIG. 16 shows optically conductive elements with holes as a part of the means for illuminating wheel according to the first embodiment of the present invention;

FIG. 17 shows each of the optically conductive elements included in the second embodiment of the present invention includes a plurality of segments; and

FIG. 18 shows differently shaped optically conductive elements may be arranged on one wheel.

### DETAILED DESCRIPTION OF THE PREFERRED EMBODIMENTS

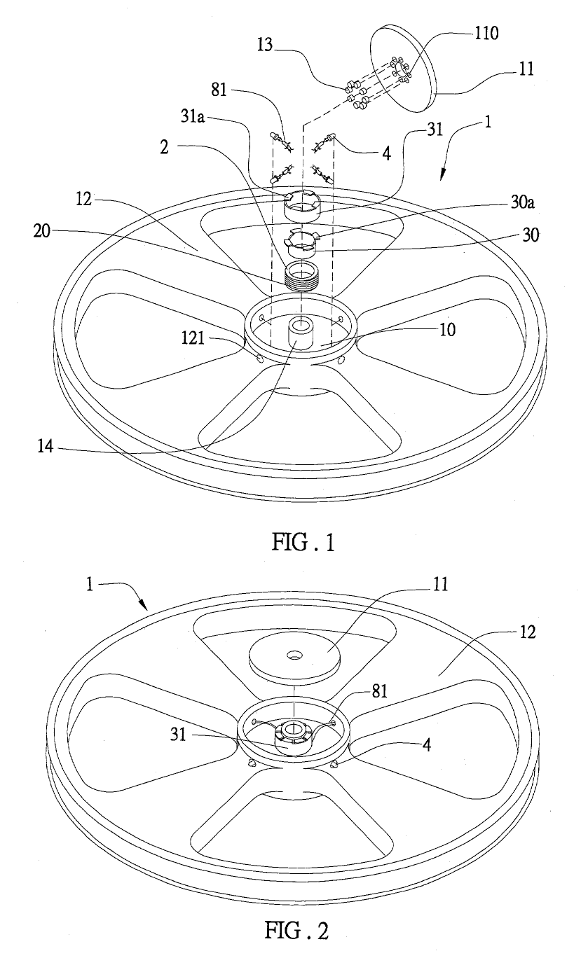

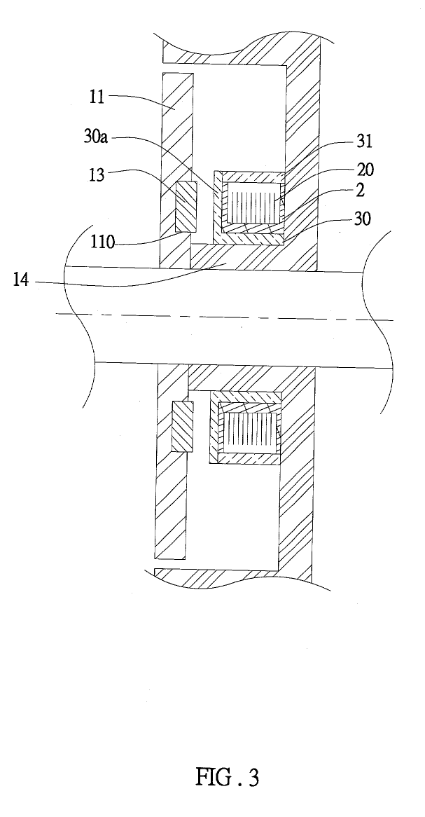

Please refer to FIGS. 1 and 2 that are exploded and assembled perspective views, respectively, of means for illuminating wheel according to a first embodiment of the present invention, and to FIG. 3 that is a fragmentary sectioned side view of FIG. 2.

As shown, the means in the first embodiment of the present invention includes a magneto-electric self-power-generating device mounted on a hub 10 of a wheel 1, and mainly including a plurality of magnets 13 and an induction coil unit. The magnets 13 are separately set in pits 110 provided at an inner surface of a magnet holder 11 that is fixed on an axle of the wheel 1. The induction coil unit is integrally mounted around a hollow shaft 14 centered at the hub 10 to locate at an inner side of the magnet holder 11. The induction coil unit mainly includes a bobbin 2 wound with a coil 20 and inner and outer magnetic poles 30, 31. The inner magnetic pole 30 is a ring-shaped member set in the bobbin 2 and having a plurality of spaced magnetic pole lugs 30a radially outward projected from one lateral side thereof. The outer magnetic pole 31 includes two halves adapted to enclose the bobbin 2 and has a plurality of spaced magnetic pole lugs 31a radially inward projected from one lateral side thereof, such that the magnetic pole lugs 30a alternate with the magnetic pole lugs 31a along one side of the bobbin 2. The magnets 13 set in the magnet holder 11 are in a number equal to a total number of the magnetic pole lugs 30a and 31a of the induction coil unit. A lead-out wire 81 of the coil 20 is connected to light emitting elements 4. The whole wheel 1 may be made of an optically conductive material, and the light emitting elements 4 are positioned in holes 121 provided at areas at where the hub 10 and spokes 12 of the wheel 1 join.

When the wheel 1 rotates at a high speed, the magnetic pole lugs 30a, 31a in the induction coil unit interact with the magnets 13 on the magnet holder 11 fixedly mounted on the axle of the wheel 1 to generate an electromotive force. That is, a magneto-electric self-power-generating effect is achieved. Electric current produced in this manner is sent via the wire 81 to the light emitting elements 4 for the latter to emit light beams. Light beams emitted from the light emitting elements 4 are transmitted outward via the optically conductive spokes 12, so as to provide a visually good warning effect.

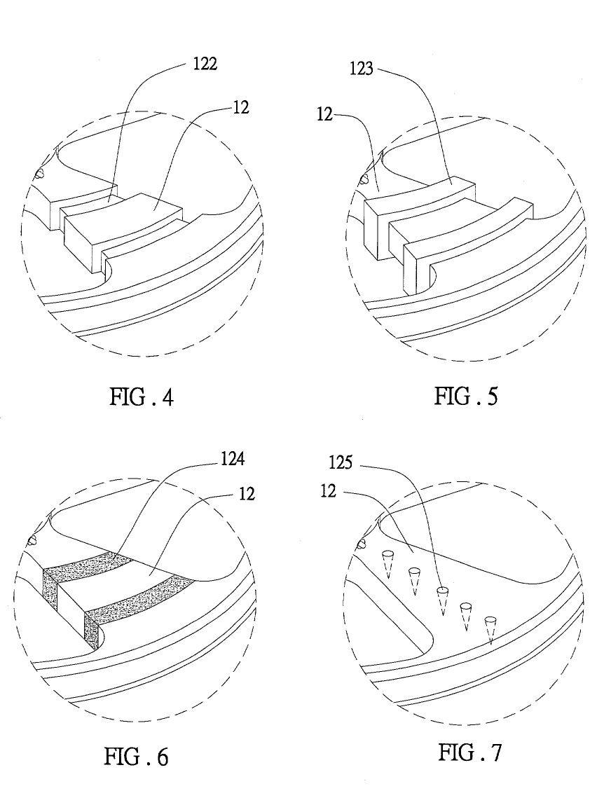

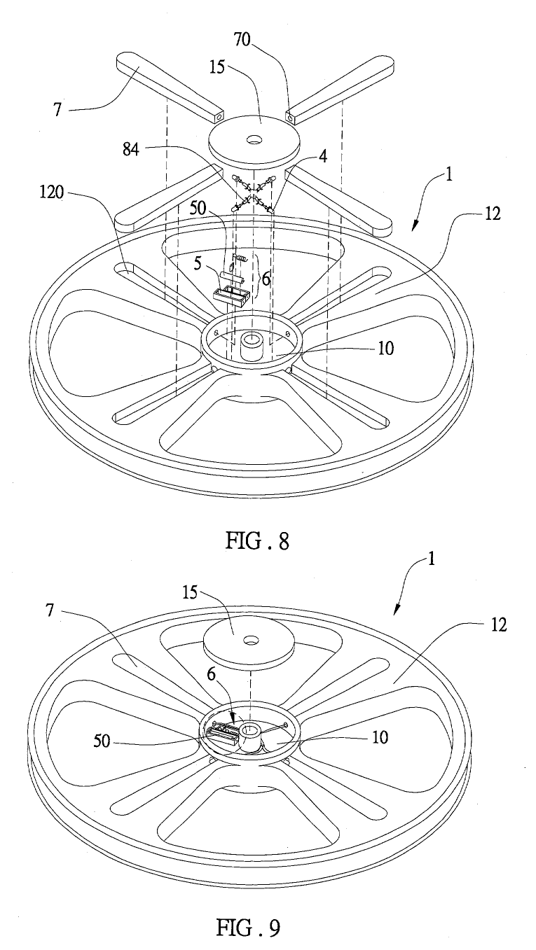

The spokes 12 of the wheel 1 are optically conductive and may be further provided on outer surfaces with grooves 122, flanges 123, coarse areas 124 or holes 125, as sequentially shown from FIGS. 4 to 7. Since light is reflected and refracted at an interface between two different media, the light beams emitted from the light emitting elements 4 and transmitted through the spokes 12 are reflected and refracted at these grooves 122, flanges 123, coarse areas 124 and/or holes 125, making the light beam from each light emitting element 4, which is in the form of a single light source, to produce multiple light spots on the wheel 1. When the wheel 1 rotates, these light spots create a visual effect that the whole rotating wheel 1 is illuminated. It is not necessary for all the spokes 12 to be uniformly provided with the grooves 122, the flanges 123, the coarse areas 124, or the holes 125. These designs may be selectively, alternately, or randomly provided on the spokes 12.

The wheel 1 made of the optically conductive material is very suitable for use with bicycles, tricycles for children, and strollers for babies.

Please refer to FIGS. 8 and 9 that are exploded and assembled perspective views, respectively, of means for illuminating wheel according to a second embodiment of the present invention. In this embodiment, the same reference numerals are used to denote elements the same as or similar to those in the first embodiment.

The illuminating means in the second embodiment of the present invention includes a centrifugal type self-power-generating device mounted on the hub 10 of the wheel 1, and a plurality of optically conductive elements 7.

The centrifugal type self-power-generating device mainly includes a battery box 5 having a battery 50 mounted therein to supply power needed by the light emitting elements 4 to emit light, and a centrifugal switch 6.

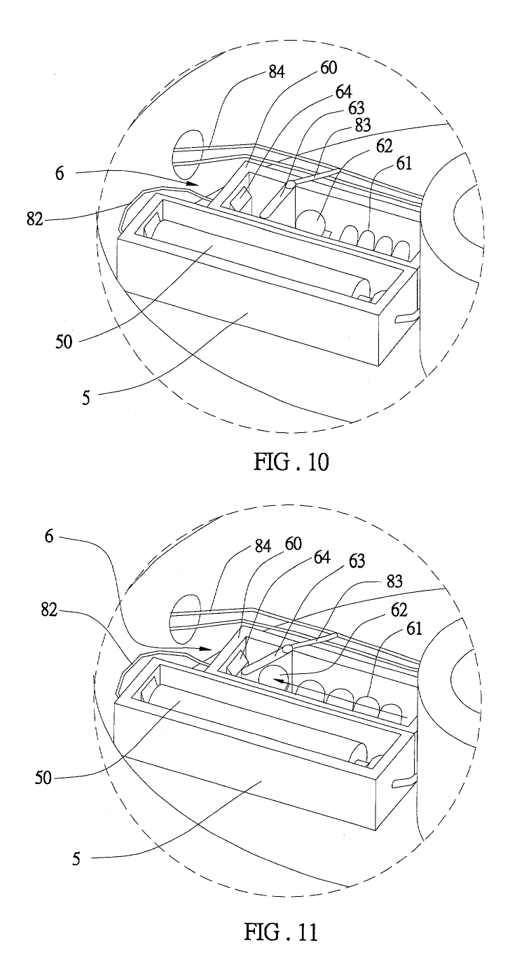

Please refer to FIGS. 10 and 11 at the same time. The centrifugal switch 6 includes a box 60 that is connected to the hub 10 to extend in a radial direction and has a spring 61, a hammer 62, an elastic plate 63, and a conductive plate 64 sequentially disposed therein from inner to outer end. The spring 61 is connected at an inner end to an inner transverse end wall of the box 60 and at an outer end to the hammer 62. The conductive plate 64 is fixedly connected to an outer transverse end wall of the box 60 and is indirectly connected to a positive electrode of the battery 50 via a wire 82. The elastic plate 63 is fixedly connected to a longitudinal wall of the box 60 and is indirectly connected to a negative electrode of the battery 50 via a wire 83.

Light emitting elements 4 are connected to the centrifugal type self-power-generating device via wires 84. An outer cover 15 is closed onto the hub 10 to protectively enclose the whole centrifugal type self-power-generating device in the hub 10.

The optically conductive elements 7 are firmly connected to the wheel 1 by separately setting them in openings 120 provided at the spokes 12. Each of the optically conductive elements 7 is provided at a front end pointing toward the hub 10 with a hole 70 for one light emitting element 4 to locate therein.

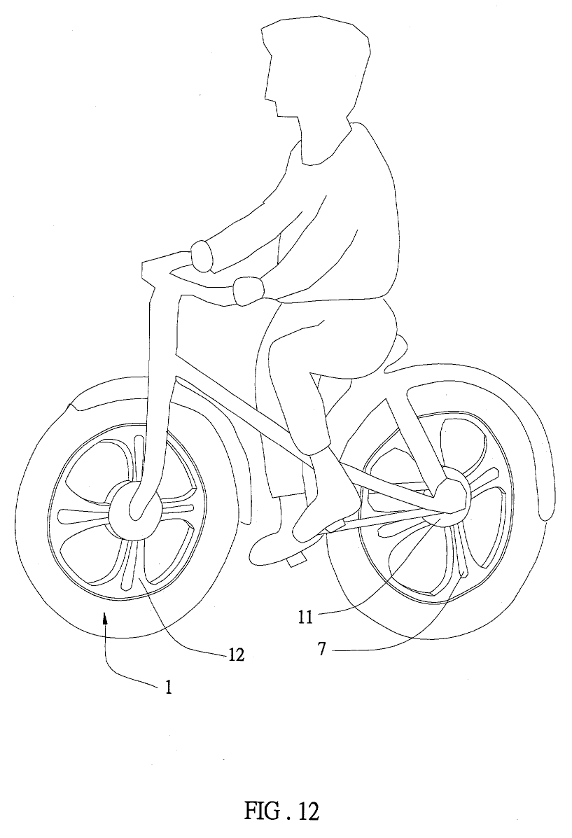

FIG. 12 shows a bicycle that has wheels 1 with the illuminating means of the present invention. Please refer to FIGS. 9 to 12 at the same time, particularly to FIGS. 10 and 11. When the wheel 1 rotates, a centrifugal force is generated to radially outward throw the spring 61 in the box 60 of the centrifugal switch 6, causing the hammer 62 connected to the outer end of the spring 61 to press against the elastic plate 63 for the latter to contact with the conductive plate 64. At this point, a closed circuit is formed between the centrifugal switch 6 and the battery 50, as shown in FIG. 11, to drive the light emitting elements 4 to emit light beams, which are outward transmitted via the optically conductive elements 7 and provides a visually good warning effect.

The optically conductive elements 7 may be of any shape, such as bars, strips, etc., and may be provided with any desired designs or patterns, such as a manufacturer's or a customer's logo, and may be in different colors, to create a colorful, unique and changeful appearance for the wheel 1 when the latter is rotating.

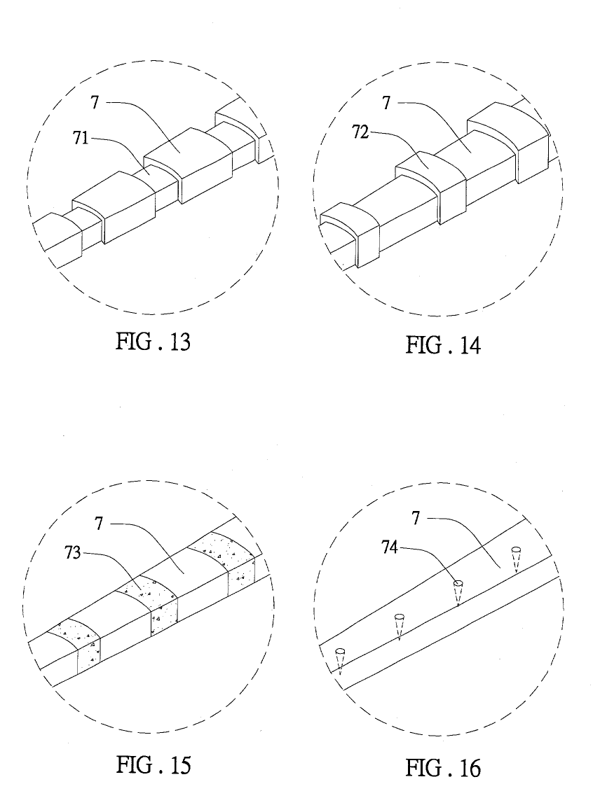

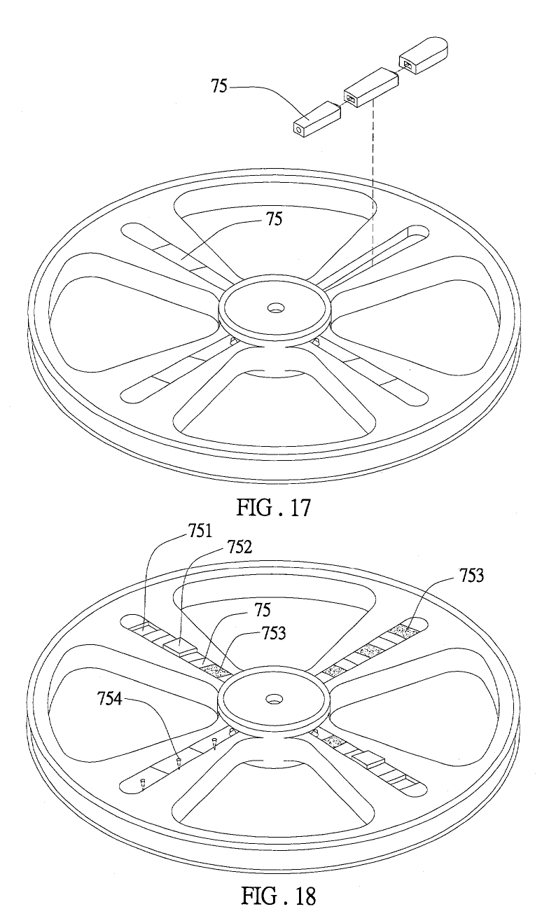

The optically conductive elements 7 may be further provided on outer surfaces with grooves 71, flanges 72, coarse areas 73 or holes 74, as sequentially shown from FIGS. 13 to 16. Since light is reflected and refracted at an interface between two different media, the light beams emitted from the light emitting elements 4 and transmitted through the optically conductive elements 7 are reflected and refracted at these grooves 71, flanges 72, coarse areas 73 and/or holes 74, making the light beam from each light emitting element 4, which is in the form of a single light source, to produce multiple light spots on the wheel 1. When the wheel 1 rotates, these light spots create a visual effect that the whole rotating wheel 1 is illuminated. It is not necessary to set optically conductive elements 7 showing uniform grooves 71, flanges 72, coarse areas 73, or holes 74 on each wheel 1. In stead, optically conductive elements 7 showing different surface designs may be selectively, alternately, or randomly provided on different spokes 12 of the wheel 1.

Each of the optically conductive elements 7 may include either one single integral member, as shown in FIGS. 8 and 9, or more than one segment 75, as shown in FIG. 17. In the latter case, each segment 75 of the optically conductive element 7 may also be separately provided at outer surfaces with grooves 751, flanges 752, coarse areas 753 or holes 754. The segments 75 are designed to be connectable with one another. Therefore, one optically conductive element 7 shown in FIG. 17 may also include segments 75 having different surface designs. A user may freely select different combinations of segments 75 for each optically conductive element 7 to create more changes in illuminating the wheel 1.

It is understood the self-power-generating device for the present invention are not limited to the above-described two types. Any other type of power generating unit, such as vibration type self-power-generating device or non-self-contained battery power generating device, that is adapted to supply power needed by the light emitting elements 4 and use with the optically conductive elements 7 should be included in the spirit of the invention. In other words, the present invention has been described with some preferred embodiments thereof and it is understood that many changes and modifications in the described embodiments can be carried out without departing from the scope and the spirit of the invention as defined by the appended claims.

What is claimed is:

1. A means for illuminating wheel, comprising a wheel made of an optically conductive material and including a hub and a plurality of spokes, a power supply device connected to said hub of said wheel, and a plurality of light emitting elements connected to said power supply device to obtain power for emitting light beams and separately mounted in said spokes of said wheel; whereby light beams emitted from said light emitting elements are transmitted outward via said optically conductive spokes of said wheel to provide a visually good warning effect.

2. The means for illuminating wheel as claimed in claim 1, wherein each of said spokes of said wheel is provided on outer surfaces with a plurality of grooves, flanges, coarse areas or holes, at where light beams emitted from said light beams emitting elements, which are in the form of single light source, are reflected and refracted to produce multiple light spots that create a visual effect that an entire surface of said wheel in rotating is illuminated.

3. The means for illuminating wheel as claimed in claim 1, wherein said power supply device is selected from the group consisting of magneto-electric type, centrifugal type, and vibration type of self-power-generating devices, and non-self-contained battery power-generating device.

4. A means for illuminating wheel, comprising a wheel having a hub and a plurality of spokes, a power supply device connected to said hub of said wheel, a plurality of optically conductive elements separately fixedly mounted on said spokes of said wheel, and a plurality of light emitting elements connected to said power supply device to obtain power for emitting light beams and separately mounted in said optically conductive elements; whereby light beams emitted from said light emitting elements are transmitted outward via said optically conductive elements to provide a visually good warning effect.

5. The means for illuminating wheel as claimed in claim 4, wherein said optically conductive elements may be of any shape, configuration, and color.

6. The means for illuminating wheel as claimed in claim 4, wherein each of said optically conductive elements may be an integrally formed member or include a plurality of connectable segments.

7. The means for illuminating wheel as claimed in claim 4, wherein each of said optically conductive elements is provided on outer surfaces with a plurality of grooves, flanges, coarse areas or holes, at where light beams emitted from said light emitting elements, which are in the form of single light source, are reflected and refracted to produce multiple light spots that create a visual effect that an entire surface of said wheel in rotating is illuminated.

8. The means for illuminating wheel as claimed in claim 4, wherein said power supply means is selected from the group consisting of magneto-electric type, centrifugal type, and vibration type self-power-generating devices, and non-self-contained battery power-generating device.
